(19) United States
(12) Patent Application Publication
(10) Pub. No.: US 2014/0156277 A1
(43) Pub. Date: Jun. 5, 2014

(54) INFORMATION PROCESSING DEVICE AND CONTENT RETRIEVAL METHOD

(71) Applicant: Kabushiki Kaisha Toshiba, Tokyo (JP)

(72) Inventors: Hiroko FUJII, Komae-shi (JP); Masaru SAKAI, Hakui-shi (JP); Masayuki OKAMOTO, Kawasaki-shi (JP); Daisuke SANO, Suginami-ku (JP)

(73) Assignee: Kabushiki Kaisha Toshiba, Tokyo (JP)

(21) Appl. No.: 14/013,887

(22) Filed: Aug. 29, 2013

(30) Foreign Application Priority Data
Nov. 30, 2012 (JP) 2012-263723

(51) Int. Cl. G10L 15/08

(52) U.S. Cl. CPC G10L 15/08
USPC 704/251

(57) ABSTRACT

According to one embodiment, an information processing device includes: an input module configured to receive voice input therein; a display controller configured to identify from the input voice a keyword and a single piece of attribute information associated with the keyword to be used for content retrieval and to cause to display on a display the identified keyword and the identified attribute information, and attribute candidate information that is associated with the identified keyword and selectable as an alternative to the identified attribute information; and a retrieval instructing module configured to give an instruction for the content retrieval using the identified keyword and the selected attribute candidate information.

### CROSS-REFERENCE TO RELATED APPLICATIONS

This application is based upon and claims the benefit of priority from Japanese Patent Application No. 2012-263723, filed Nov. 30, 2012, the entire contents of which are incorporated herein by reference.

### FIELD

Embodiments described herein relate generally to information processing devices and content retrieval methods.

### BACKGROUND

Disclosed is a known technique for identifying from information, such as an input voice, a keyword and attribute information associated therewith, such as a type of the keyword (e.g., if the keyword is “movies”, “category” as attribute information), to be used for a content retrieval and, while displaying the identified keyword and attribute information, performing a search for the content using the identified keyword and attribute information. Disclosed is another known technique for calculating an error rate for each keyword identified from an input voice and allowing a user to issue an instruction to correct a keyword having a high calculated error rate.

In “Koe-Kara” by Sony Marketing (Japan) Inc., however, if the attribute information associated with the identified keyword has an error, all pieces of information need to be input again so that the attribute information of the identified keyword is desired attribute information, which offers only poor convenience in content retrieval processing. In Japanese Patent Application Laid-open No. 2007-264229, whereas an instruction can be issued to correct a keyword having a high error rate, no instruction can be issued to correct any keyword having low error rates even when a user's intention is not met.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a configuration of a content retrieval system according to an embodiment;

FIG. 2 is an exemplary diagram illustrating a hardware configuration of a tablet terminal in the embodiment;

FIG. 3 is an exemplary block diagram illustrating a functional configuration of the tablet terminal in the embodiment;

FIG. 4 is an exemplary block diagram illustrating a functional configuration of a new request processor of the tablet terminal in the embodiment;

FIG. 5 is an exemplary diagram illustrating a data configuration of a paraphrase knowledge database (DB) of the tablet terminal in the embodiment;

FIG. 6 is an exemplary diagram illustrating a data configuration of a request analysis information DB of the tablet terminal in the embodiment;

FIG. 7 is an exemplary block diagram illustrating a functional configuration of a change request processor of the tablet terminal in the embodiment;

FIG. 8 is an exemplary flowchart illustrating steps of a content retrieval process performed by the new request processor of the tablet terminal in the embodiment;

FIG. 9A is an exemplary diagram illustrating a content retrieval screen displayed on a display module of the tablet terminal in the embodiment;

FIG. 9B is an exemplary diagram illustrating a content retrieval screen displayed on the display module of the tablet terminal in the embodiment;

FIG. 10 is an exemplary diagram illustrating an analysis of text performed by an intention analyzer of the tablet terminal in the embodiment;

FIG. 11 is an exemplary diagram illustrating a content retrieval screen displayed on the display module of the tablet terminal in the embodiment;

FIG. 12 is an exemplary diagram illustrating a content retrieval screen displayed on the display module of the tablet terminal in the embodiment;

FIG. 13 is an exemplary flowchart illustrating steps of a retrieval condition change process performed by the change request processor of the tablet terminal in the embodiment;

FIG. 14 is an exemplary flowchart illustrating steps of a change keyword identifying process performed by the change processor of the tablet terminal in the embodiment; and

FIG. 15 is an exemplary diagram illustrating a content retrieval screen displayed on the display module of the tablet terminal in the embodiment.

### DETAILED DESCRIPTION

In general, according to one embodiment, an information processing device comprises: an input module configured to receive voice input therein; a display controller configured to identify from the input voice a keyword and a single piece of attribute information associated with the keyword to be used for content retrieval and to cause to display on a display the identified keyword and the identified attribute information, and attribute candidate information that is associated with the identified keyword and selectable as an alternative to the identified attribute information; and a retrieval instructing module configured to give an instruction for the content retrieval using the identified keyword and the selected attribute candidate information.

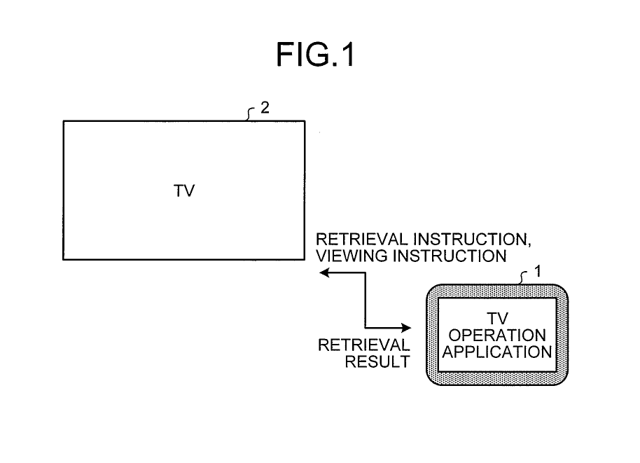

FIG. 1 is a block diagram illustrating a configuration of a content retrieval system according to an embodiment. As illustrated in FIG. 1, the content retrieval system in the embodiment comprises a tablet terminal 1 and a television broadcast display set 2.

The tablet terminal 1 is an exemplary information processing device that analyzes information, such as an input voice, using a previously installed television operation application and, based on an analysis thereof, transmits a retrieval instruction to retrieve content, such as a broadcast program, to the television broadcast display set 2.

When a specific piece of content to be displayed is determined as selected from among different pieces of content retrieved in the television broadcast display set 2, the tablet terminal 1 generates a viewing instruction to display the determined specific piece of content and transmits the viewing instruction to the television broadcast display set 2.

The television broadcast display set 2 performs a content retrieval according to the retrieval instruction received from the tablet terminal 1 and transmits a retrieval result to the tablet terminal 1. The television broadcast display set 2 also displays the specific piece of content to be displayed according to the viewing instruction received from the tablet terminal 1.

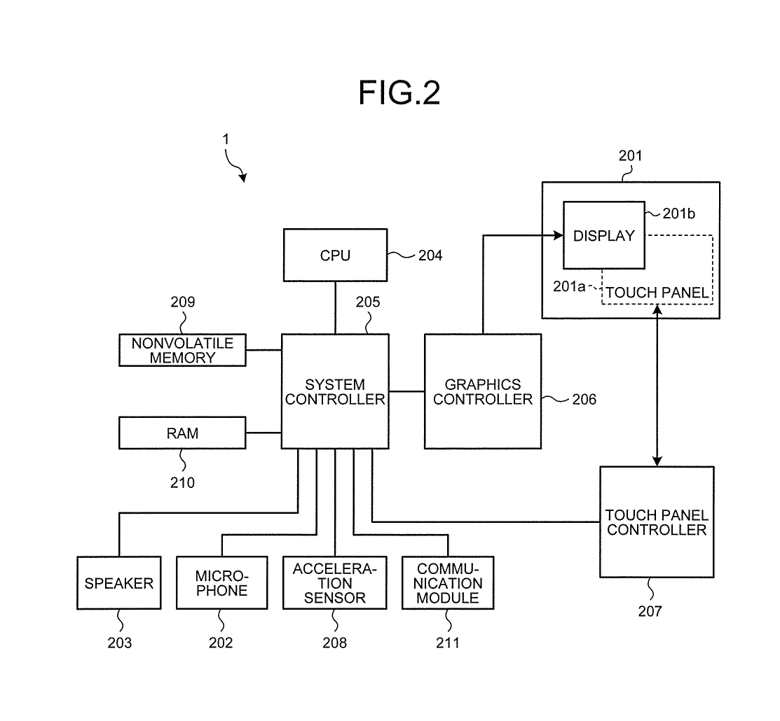

FIG. 2 is a diagram illustrating a hardware configuration of the tablet terminal in the embodiment. As illustrated in FIG. 2, the tablet terminal 1 in the embodiment comprises, for example, a display module 201, a microphone 202, a speaker 203, a central processing unit (CPU) 204, a system controller 205, a graphics controller 206, a touch panel controller 207, an acceleration sensor 208, a nonvolatile memory 209, a random access memory (RAM) 210, and a communication module 211.

The display module 201 comprises a touch panel 201a and a display 201b that may, for example, be a liquid crystal display (LCD) or an organic electroluminescence (EL) display. The touch panel 201a is a transparent coordinate detector disposed on the display 201b. The touch panel 201a detects a position on the display 201b touched by a user's finger (a touch position). The display 201b displays various types of information.

The microphone 202 is an exemplary input module in which a voice uttered by the user is input. The speaker 203 outputs a voice to the user.

The CPU 204 is a controller that controls operations of different sections of the tablet terminal 1. In the embodiment, the CPU 204 controls the different sections of the tablet terminal 1 via the system controller 205. The CPU 204 executes various types of application programs including an operating system and the television operation application loaded in the RAM 210 from the nonvolatile memory 209. The RAM 210 functions as a main memory of the tablet terminal 1.

The system controller 205 has a function as a memory controller that controls access to the nonvolatile memory 209 and the RAM 210. The system controller 205 also has a function of performing communication with the graphics controller 206.

The graphics controller 206 is a display controller that controls the display 201b. Controlling the touch panel 201a, the touch panel controller 207 acquires from the touch panel 201a coordinate data indicative of a position on the display 201b touched by the user.

The acceleration sensor 208 detects an orientation and a magnitude of acceleration of the tablet terminal 1 and outputs the detected data to the CPU 204.

The communication module 211 is a communication interface that can be connected to a network (not illustrated), such as the Internet. The communication module 211 transmits or receives various types of information to or from an external device (e.g., the television broadcast display set 2) connected to the network under the control of the system controller 205.

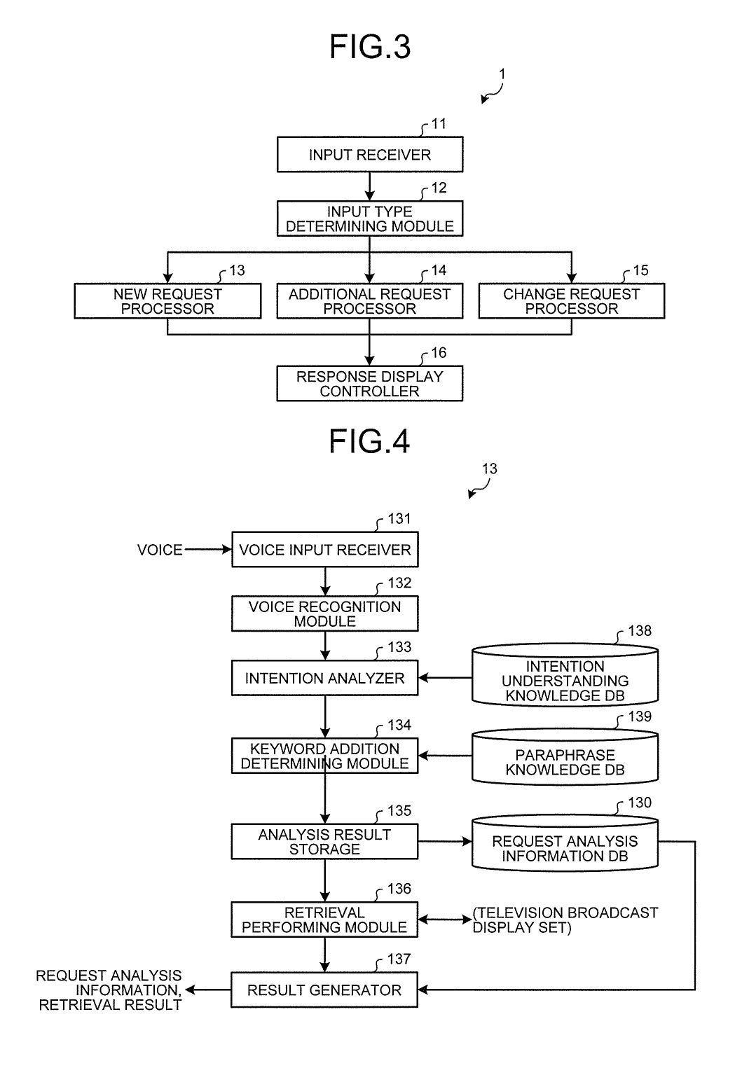

FIG. 3 is a block diagram illustrating a functional configuration of the tablet terminal in the embodiment. The tablet terminal 1 of the embodiment executes the television operation application stored in the nonvolatile memory 209 to thereby function, as illustrated in FIG. 3, as an input receiver 11, an input type determining module 12, a new request processor 13, an additional request processor 14, a change request processor 15, and a response display controller 16.

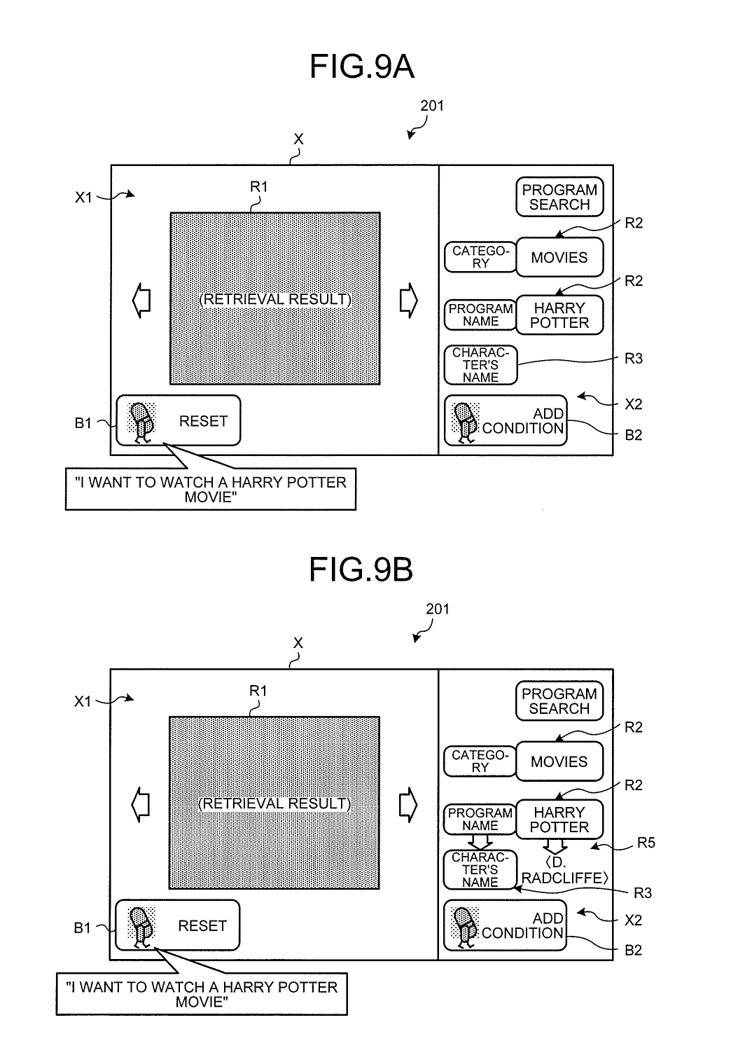

The input receiver 11 receives user inputs. In the embodiment, the “user inputs” include, but not limited to, the user's depressing a “Reset” button B1 (see FIG. 9A) or an “Add condition” button B2 (see FIG. 9A), selecting a keyword to be changed including retrieval conditions R2 (see FIG. 9A), and selecting attribute candidate information R3 (see FIG. 9A).

The input type determining module 12 determines a specific instruction from the user according to the user input received by the input receiver 11. In the embodiment, the input type determining module 12 determines according to the user input whether the instruction from the user is a new retrieval instruction to retrieve a new piece of content, a condition addition instruction to add a retrieval condition, or a condition change instruction to change a part of the retrieval conditions.

Specifically, the input type determining module 12 determines a user input indicative of the depression of the “Reset” button 51 (see FIG. 9A), if received, to be a new retrieval instruction. Similarly, the input type determining module 12 determines a user input indicative of the depression of the “Add condition” button B2 (see FIG. 9A), if received, to be a condition addition instruction. Similarly, the input type determining module 12 determines a user input indicative of the selection of a keyword to be changed included in the retrieval conditions R2 (see FIG. 9A) or the attribute candidate information R3 (see FIG. 9A), if received, to be a condition change instruction.

If the input type determining module 12 determines a new retrieval instruction, the new request processor 13 identifies the new retrieval condition and performs a content retrieval process according to the identified new retrieval condition.

If the input type determining module 12 determines a condition addition instruction, the additional request processor 14 performs a process to add a new retrieval condition to the retrieval conditions used in the retrieval process performed most recently.

If the input type determining module 12 determines a condition change instruction, the change request processor 15 performs a process to change a part of the retrieval conditions currently displayed on a content retrieval screen X (see FIG. 9A).

The response display controller 16 displays on the display 201b a result of each of the processes performed by the new request processor 13, the additional request processor 14, and the change request processor 15.

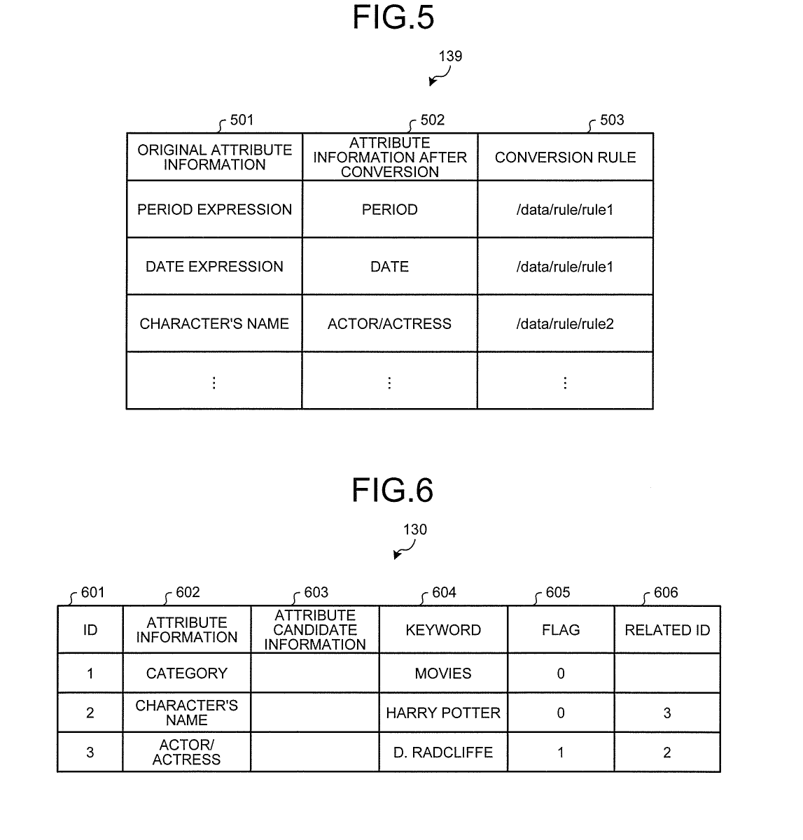

FIG. 4 is a block diagram illustrating a functional configuration of the new request processor of the tablet terminal in the embodiment. FIG. 5 is a diagram illustrating a data configuration of a paraphrase knowledge database (DB) of the tablet terminal in the embodiment. FIG. 6 is a diagram illustrating a data configuration of a request analysis information DB of the tablet terminal in the embodiment. As illustrated in FIG. 4, the new request processor 13 comprises a voice input receiver 131, a voice recognition module 132, an intention analyzer 133, a keyword addition determining module 134, an analysis result storage 135, a retrieval performing module 136, and a result generator 137. An intention understanding knowledge DB 138, a paraphrase knowledge DB 139, and a request analysis information DB 130 are stored in the RAM 210 (see FIG. 2) of the tablet terminal 1.

The voice input receiver 131 receives voice input from the microphone 202. The embodiment will be described for a configuration in which voice is received as information to be used for content retrieval. This is, however, not the only possible configuration; alternatively, for example, natural language and handwriting may be received as the information to be used for content retrieval.

The voice recognition module 132 recognizes the voice received by the voice input receiver 131 and converts the voice to text. The process of recognizing the voice received by the voice input receiver 131 may be performed using a voice recognition function the tablet terminal 1 or an external device has.

The intention analyzer 133 refers to the intention understanding knowledge DB 138 to thereby analyze the text converted from the voice by the voice recognition module 132 and identify a keyword to be used for retrieval of content, such as a broadcast program, and a single piece of attribute information associated with the keyword and to be used for the content retrieval. In the embodiment, a plurality of pieces of attribute information that can be identified as a single piece of attribute information associated with the keyword (e.g., “category”, “character's name”, “actor/actress”, “period”, “period expression”, “date expression”, “broadcast station”, “program name”, “CS”, and “BS”) are set in advance. The intention analyzer 133, therefore, identifies a single piece of attribute information associated with the keyword identified with the text from among the previously set multiple pieces of attribute information.

Assume, for example, that the text converted from the voice by the voice recognition module 132 reads, “Find a movie or movies in which the actor as Harry Potter appears”. The intention analyzer 133 then identifies the keyword “Harry Potter” and the attribute information “character's name” and the keyword “movies” and the attribute information “category”.

If, among the previously set multiple pieces of attribute information, there are involved a plurality of pieces of attribute information associated with the identified keyword, the intention analyzer 133 identifies one of the multiple pieces of attribute information as a single piece of attribute information to be used for the content retrieval. In addition, the intention analyzer 133 identifies those pieces of attribute information other than the single piece of attribute information in question as pieces of attribute candidate information that are associated with the identified keyword and that can be selected as alternatives to the single piece of attribute information in question.

By following a previously set conversion rule 503 (see FIG. 5), the keyword addition determining module 134 converts the keyword and the attribute information identified by the intention analyzer 133 to a second keyword and attribute information associated with the second keyword to be used for the content retrieval in place of the previously identified keyword and attribute information. In the embodiment, the keyword addition determining module 134 determines whether the identified keyword can be directly used for the content retrieval based on the identified attribute information. To state the foregoing differently, the keyword addition determining module 134 determines whether there is any other keyword to be used for the content retrieval in place of the identified keyword, or whether the identified keyword requires paraphrasing. If determining that the identified keyword cannot be directly used for the content retrieval, the keyword addition determining module 134 converts the identified keyword to the second keyword and the second piece of attribute information.

In the embodiment, as illustrated in FIG. 5, the paraphrase knowledge DB 139 stores therein attribute information associated with keywords to be converted to second keywords (original attribute information) 501, attribute information associated with the second keywords (attribute information after conversion) 502, and a rule governing conversion from the identified keywords to the second keywords (conversion rule) 503, all being correlated with each other. If the single piece of attribute information associated with the keyword identified by the intention analyzer 133 falls into any of pieces of the original attribute information 501 stored in the paraphrase knowledge DB 139, the keyword addition determining module 134 determines that there is another keyword to be used for the content retrieval in place of the identified keyword. By following the conversion rule 503, the keyword addition determining module 134 then converts the identified keyword to a second keyword such that the attribute information associated with the identified keyword (the original attribute information 501) is the attribute information after conversion 502 stored in the paraphrase knowledge DB 139.

For example, the attribute information “character's name” associated with the keyword “Harry Potter” identified by the intention analyzer 133 falls into “character's name” of the original attribute information 501 stored in the paraphrase knowledge DB 139. The keyword addition determining module 134 thus converts, by following the conversion rule 503, the keyword “Harry Potter” to a second keyword “D. Radcliffe” such that the “character's name” is “actor/actress” of the attribute information after conversion 502.

In the embodiment, the keyword addition determining module 134 follows the conversion rule 503 previously stored in the paraphrase knowledge DB 139 to perform conversion to the second keyword and the second attribute information. However, the conversion to the second keyword and the second attribute information may instead be performed using, for example, EPG information or web information as follows. Specifically, a correspondence between each of keywords (e.g., “Harry Potter”) corresponding to the original attribute information 501 (e.g., “character's name”) and a corresponding one of second keywords (e.g., “D. Radcliffe”) associated with the attribute information after conversion 502 (e.g., “actor/actress”) is acquired; then, based on the acquired correspondence, the conversion rule 503 is generated; and the conversion to the second keyword and the second attribute information is performed by following the generated conversion rule 503.

The analysis result storage 135 stores in the request analysis information DB 130 (see FIG. 6) request analysis information including the keyword and the attribute information identified by the intention analyzer 133 and the attribute candidate information, and request analysis information including the second keyword and the second attribute information after the conversion by the keyword addition determining module 134. The request analysis information DB 130 stores therein, as illustrated in FIG. 6, the request analysis information for each of the keyword identified by the intention analyzer 133 or the second keyword after the conversion by the keyword addition determining module 134.

The request analysis information includes an ID 601, attribute information 602, attribute candidate information 603, a keyword 604, a flag 605, and a related ID 606. Specifically, the ID 601 identifies the request analysis information in question. The attribute information 602 is the attribute information identified by the intention analyzer 133 (or the second attribute information after the conversion by the keyword addition determining module 134). The attribute candidate information 603 is the attribute candidate information identified by the intention analyzer 133. The keyword 604 is the keyword identified by the intention analyzer 133 (or the second keyword after the conversion by the keyword addition determining module 134). The flag 605 is a marker indicating that the keyword 604 is the keyword or the second keyword. The related ID 606 represents the ID 601 of request analysis information related to the request analysis information identified by the ID 601.

In the embodiment, the flag 605 represents “0” if the keyword 604 is the keyword identified by the intention analyzer 133, and “1” if the keyword 604 is the second keyword after the conversion by the keyword addition determining module 134.

If the keyword 604 is the keyword identified by the intention analyzer 133, the related ID 606 represents an ID 601 of the request analysis information including the second keyword to be used for content retrieval in place of the keyword 604 in question. If the keyword 604 is the second keyword after the conversion by the keyword addition determining module 134, the related ID 606 represents an ID 601 of the request analysis information including the keyword (the keyword identified by the intention analyzer 133) used for identifying the keyword 604 in question.

With a new retrieval instruction, if request analysis information including, for example, a keyword (or a second keyword) identified based on voice input most recently is stored in the request analysis information DB 130, the analysis result storage 135 deletes the request analysis information in question and, instead, stores request analysis information including, for example, a keyword (or a second keyword) identified based on voice newly input is stored in the request analysis information DB 130.

The retrieval performing module 136 functions as a retrieval instructing module that directs the television broadcast display set 2 to perform content retrieval using the keyword and the attribute information identified by the intention analyzer 133. If the keyword and the attribute information identified by the intention analyzer 133 are converted to the second keyword and the second attribute information by the keyword addition determining module 134, the retrieval performing module 136 directs the television broadcast display set 2 to perform content retrieval using the second keyword and the second attribute information after the conversion by the keyword addition determining module 134 in place of the keyword and the attribute information identified by the intention analyzer 133.

In the embodiment, the retrieval performing module 136 directs the content retrieval by transmitting to the television broadcast display set 2 information to be used for the retrieval (the attribute information 602 and the keyword 604) out of information included in the request analysis information stored in the request analysis information DB 130. Specifically, the retrieval performing module 136 refers to the flag 605 and the related ID 606 of the request analysis information stored in the request analysis information DB 130. If the flag 605 is “0”, the retrieval performing module 136 transmits the attribute information 602 and the keyword 604 included in the request analysis information in question. If the flag 605 of the request analysis information stored in the request analysis information DB 130 is “1”, the retrieval performing module 136 transmits the attribute information 602 (second attribute information) and the keyword 604 (second keyword) included in the request analysis information that includes the related ID 606 as the ID 601.

In the embodiment, the retrieval performing module 136 directs the television broadcast display set 2 to perform the content retrieval. The content retrieval may, nonetheless, be performed differently. Specifically, EPG information is acquired in advance from the television broadcast display set 2 and, from the acquired EPG information, the keyword 604 and the attribute information 602 included in the request analysis information are used to perform the content retrieval.

The result generator 137 outputs the request analysis information stored in the request analysis information DB 130 to the response display controller 16 to thereby cause the keyword and the attribute information identified by the intention analyzer 133 and the attribute candidate information, and the second keyword and the second attribute information after the conversion by the keyword addition determining module 134 to be displayed on the display module 201. In the embodiment, the result generator 137 causes the second keyword and the second attribute information to be displayed on the display module 201. Nonetheless, what is to be displayed on the display module 201 may be at least the keyword and the attribute information identified by the intention analyzer 133 and the attribute candidate information.

Additionally, the result generator 137 outputs a content retrieval result acquired by the retrieval performing module 136 to the response display controller 16, thereby causing the retrieval result to be displayed on the display module 201.

A functional configuration of the additional request processor 14 will be described below. The additional request processor 14 has a functional configuration identical to that of the new request processor 13 illustrated in FIG. 3. It should, however, be noted that, in the additional request processor 14, when the request analysis information including, for example, the keyword identified based on voice input for adding a retrieval condition is to be stored in the request analysis information DB 130, the request analysis information including, for example, the keyword identified based on voice input most recently is not to be deleted.

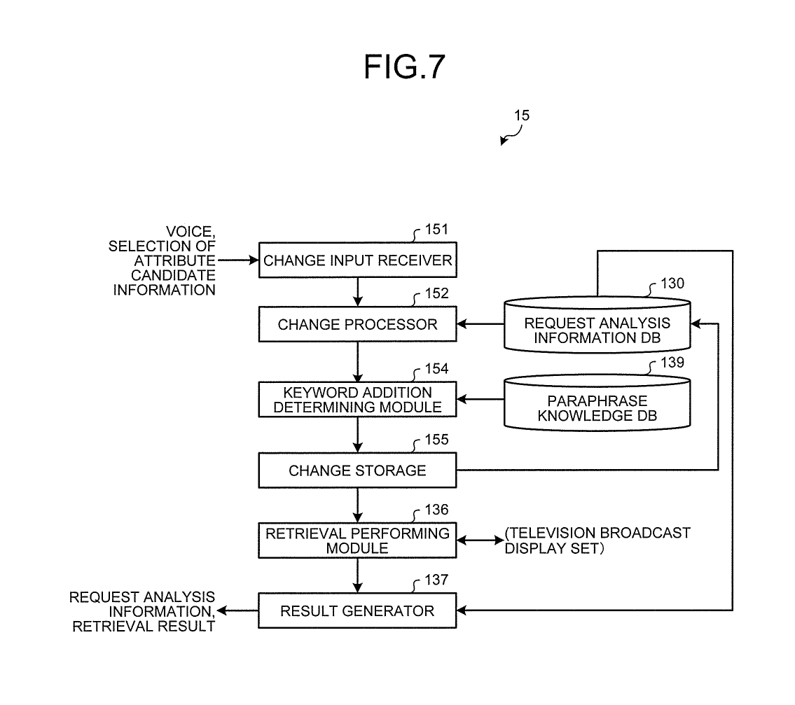

FIG. 7 is a block diagram illustrating a functional configuration of change request processor of the tablet terminal in the embodiment. As illustrated in FIG. 7, the change request processor 15 comprises a change input receiver 151, a change processor 152, a keyword addition determining module 154, a change storage 155, the retrieval performing module 136, and the result generator 137.

When a user input indicating that a keyword to be changed included in the retrieval conditions R2 (see FIG. 9A) is received, the change input receiver 151 receives voice input from the microphone 202. If a user input indicating that the attribute candidate information R3 (see FIG. 9A) has been selected is received, the change input receiver 151 receives the selection of the attribute candidate information that represents the alternative to the attribute information displayed on the display module 201.

The change processor 152 acquires from the request analysis information DB 130 the ID 601 (see FIG. 6) of the request analysis information that includes the selected keyword to be changed (or the selected attribute candidate information). For example, if the keyword 604 “Harry Potter” displayed on the display module 201 is selected as the keyword to be changed, the change processor 152 acquires the ID 601 “2” of the request analysis information that includes the keyword 604 “Harry Potter” as the keyword to be changed.

Based on the acquired ID 601, the change processor 152 identifies, out of the request analysis information stored in the request analysis information DB 130, the request analysis information that includes the acquired ID 601 (the request analysis information including the keyword 604 to be changed or the selected attribute candidate information 603). If the attribute candidate information has been selected, the change processor 152 changes the attribute information 602 included in the identified request analysis information to the selected attribute candidate information. This allows the attribute information displayed on the display module 201 to be changed for each piece of attribute information.

If the keyword to be changed has been selected, the change processor 152 recognizes the voice received by the change input receiver 151 and converts the voice to text. Then, the change processor 152 analyzes the converted text and identifies a keyword candidate to replace the keyword to be changed (hereinafter referred to as “change keyword”) and the attribute information associated with the change keyword. Then, using the identified change keyword, the change processor 152 changes the keyword 604 included in the identified request analysis information. This allows the keywords displayed on the display module 201 to be changed for each keyword. It is noted that, if the attribute information associated with the change keyword differs from the attribute information 602 included in the identified request analysis information, the change processor 152 changes the attribute information 602 included in the identified request analysis information using the attribute information associated with the change keyword.

If the change processor 152 has identified a plurality of change keywords, the change processor 152 selects, from among the identified multiple change keywords, a change keyword that differs from the keyword 604 included in the identified request analysis information and has the same attribute information as the attribute information 602 included in the identified request analysis information. If there are involved a plurality of change keywords that differ from the keyword 604 included in the identified request analysis information and have the same attribute information as the attribute information 602 included in the identified request analysis information, the change processor 152 selects from among the multiple change keywords the change keyword identified with the voice input last. Alternatively, the change processor 152 may cause a message that prompts the selection of one change keyword out of the multiple change keywords to be displayed on the display module 201.

If none of multiple pieces of attribute information associated with the identified plurality of change keywords is identical to the attribute information 602 included in the identified request analysis information, the change processor 152 selects from among the identified multiple change keywords the change keyword that has the same attribute information as the attribute candidate information 603 included in the identified request analysis information. If the identified multiple change keywords include no change keyword that has the same attribute information as the attribute candidate information 603 included in the identified request analysis information, the change processor 152 changes the attribute information 602 and the keyword 604 included in the identified request analysis information using, from among the multiple change keywords, the change keyword identified with the voice input last and the attribute information associated with this change keyword.

For example, if the keyword 604 to be changed “Harry Potter” is selected and the change input receiver 151 receives voice “Ethan Hunt”, the change processor 152 recognizes the voice “Ethan Hunt” and converts the voice to text. The change processor 152 then analyzes the converted text and identifies the change keyword “Ethan Hunt” and the attribute information “character's name” associated with the change keyword. Next, the change processor 152 identifies from the request analysis information DB 130 the request analysis information that includes the keyword to be changed “Harry Potter” as the keyword 604. The attribute information 602 “character's name” included in the identified request analysis information matching the attribute information “character's name” corresponding to the change keyword “Ethan Hunt”, the change processor 152 changes the keyword 604 included in the identified request analysis information to the change keyword “Ethan Hunt”.

The keyword addition determining module 154 determines, from the change keyword and the attribute information identified by the change processor 152, whether conversion to a second keyword and second attribute information is necessary using the paraphrase knowledge DB 139. If the conversion is necessary, the change keyword and the attribute information identified by the change processor 152 are converted to a second keyword and second attribute information according to the conversion rule 503.

For example, if the request analysis information having the keyword 604 “Harry Potter” changed by the change processor 152 includes the related ID 606 “3”, the keyword addition determining module 154 deletes the keyword 604 “D. Radcliffe” that is the second keyword included in the request analysis information including the ID 601 “3” of the related ID 606 “3”. The keyword addition determining module 154 then sets as the keyword 604 the second keyword “T. Cruise” to be used for content retrieval in place of the keyword “Ethan Hunt” changed from the keyword 604 “Harry Potter” by the change processor 152.

If the related ID 606 is included in the request analysis information with its attribute information 602 changed by the change processor 152, the keyword addition determining module 154 changes the keyword 604 (second keyword) and the attribute information 602 (second attribute information) included in the request analysis information that includes the ID 601 of the related ID 606.

The change storage 155 stores the request analysis information having the keyword 604 or the attribute information 602 changed by the change processor 152 or the keyword addition determining module 154 in the request analysis information DB 130. If the request analysis information having the keyword 604 “Harry Potter” changed by the change processor 152 includes the related ID 606 “3” and if the change keyword does not require conversion to the second keyword, the request analysis information that includes the ID 601 “3” for the related ID 606 “3” is deleted. If the request analysis information having the keyword 604 “Harry Potter” changed by the change processor 152 includes the related ID 606 “3” and if the change keyword requires the conversion to the second keyword, the request analysis information that includes the ID 601 “3” for the related ID 606 “3” is deleted and the request analysis information that includes the new second keyword “T. Cruise” and the second attribute information “actor/actress” is stored.

In the embodiment, when the change processor 152 or the keyword addition determining module 154 changes the keyword 604 or the attribute information 602 included in the request analysis information, the keyword 604 or the attribute information 602 included in the request analysis information before the change is deleted. The keyword 604 or the attribute information 602 included in the request analysis information before the change may be saved as a history and, in response to an instruction to restore the last keyword 604 or attribute information 602, the keyword 604 or the attribute information 602 included in the request analysis information before the change may be restored.

If the attribute candidate information that represents the alternative to the attribute information is selected, the retrieval performing module 136 directs the content retrieval using the selected attribute candidate information.

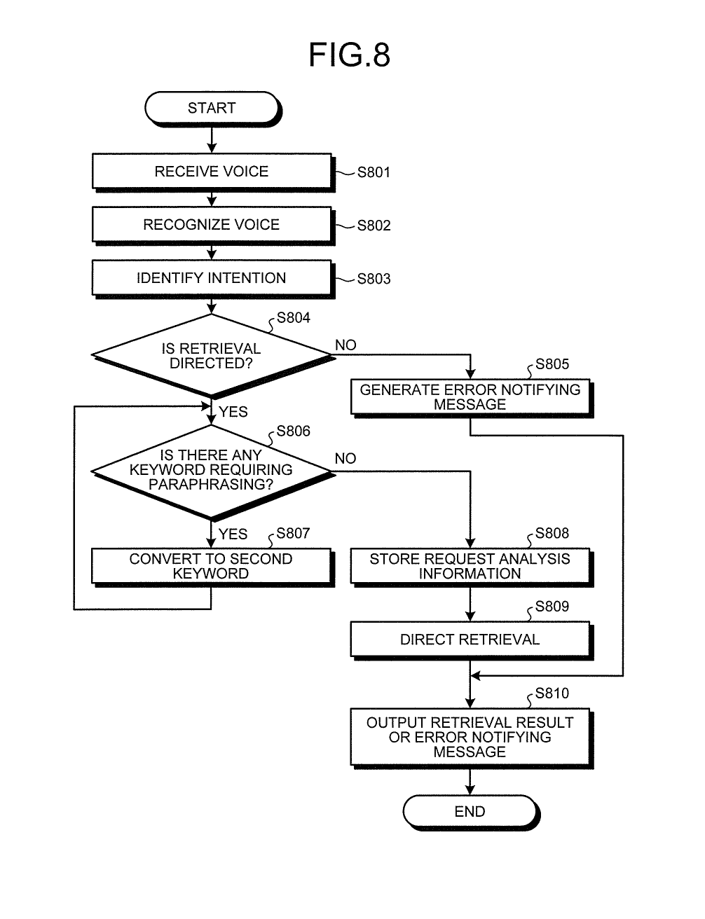

Steps of a content retrieval process performed by the new request processor 13 will be described below. FIG. 8 is a flowchart illustrating steps of the content retrieval process performed by the new request processor of the tablet terminal in the embodiment. FIGS. 9A and 9B are exemplary diagrams illustrating content retrieval screens displayed on the display module of the tablet terminal in the embodiment.

In the embodiment, the response display controller 16 displays the content retrieval screen X on the display module 201 prior to the content retrieval process performed by the new request processor 13. As illustrated in FIG. 9A, the content retrieval screen X comprises a retrieval result display area X1 and a retrieval condition display area X2. More specifically, the retrieval result display area X1 displays the “Reset” button B1 used to direct reception of voice used for identifying a new retrieval condition and a content retrieval result R1. The retrieval condition display area X2 displays the “Add condition” button B2 used to direct reception of voice used for adding a new retrieval condition, the retrieval conditions R2, and the attribute candidate information R3.

When the “Reset” button B1 (see FIG. 9A) is depressed and the input type determining module 12 determines a new retrieval instruction, the voice input receiver 131 receives voice (e.g., “I want to watch a Harry Potter movie”) input from the microphone 202 (S801).

The voice recognition module 132 refers to the intention understanding knowledge DB 138, recognizes the voice received by the voice input receiver 131, and converts the voice to text (S802). The intention analyzer 133 analyzes the text converted from the voice by the voice recognition module 132 to thereby identify the intention of the input voice, and a keyword to be used for the content retrieval and a single piece of attribute information associated with the keyword and to be used for the content retrieval (S803). At this time, if there is another piece of attribute information associated with the identified keyword but different from the identified single piece of attribute information, the intention analyzer 133 identifies the another piece of attribute information as the attribute candidate information.

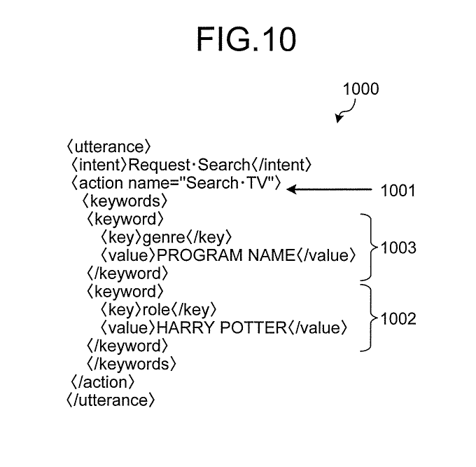

FIG. 10 is an exemplary diagram illustrating an analysis of text performed by the intention analyzer of the tablet terminal in the embodiment. When, for example, the “Reset” button B1 is depressed and the voice “I want to watch a Harry Potter movie” is input from the microphone 202, the intention analyzer 133 analyzes the text converted from the voice by the voice recognition module 132 and obtains a text analysis result 1000 illustrated in FIG. 10. Then, from the text analysis result 1000, the intention analyzer 133 identifies an intention 1001 “‘Search-TV’” of the input voice, a keyword 1002 “Harry Potter” to be used for content retrieval, and attribute information 1003 “program name” associated with the keyword 1002.

Reference is now made back to FIG. 8. The intention analyzer 133 determines, based on the intention of the input voice, whether the input voice is a content retrieval instruction (S804). For example, if the identified intention of the voice is the intention 1001 “‘Search-TV’” illustrated in FIG. 10, the intention analyzer 133 determines a content retrieval instruction. If the intention analyzer 133 determines that the input voice is not a content retrieval instruction (No at S804), the result generator 137 generates an error notifying message that notifies that the input voice has not been determined to be a content retrieval instruction (S805). The result generator 137 then outputs the generated error notifying message to the response display controller 16 (S810). This results in the result generator 137 displaying the error notifying message on the display module 201, so that a second input of voice is prompted.

If the intention analyzer 133 determines that the input voice is a content retrieval instruction (Yes at S804), the keyword addition determining module 134 determines whether the keyword identified by the intention analyzer 133 requires paraphrasing (S806). To state the foregoing differently, the keyword addition determining module 134 determines whether there are a second keyword and second attribute information to be used for the content retrieval in place of the identified keyword and attribute information. In the embodiment, if the attribute information associated with the keyword identified by the intention analyzer 133 falls into any of pieces of the original attribute information 501 stored in the paraphrase knowledge DB 139, the keyword addition determining module 134 determines that the identified keyword can be converted to the second keyword.

The keyword addition determining module 134, if determining that the keyword identified by the intention analyzer 133 requires paraphrasing (Yes at S806), follows the conversion rule 503 stored in the paraphrase knowledge DB 139 and converts the identified keyword and attribute information to the second keyword and the second attribute information associated with the second keyword to be used for the content retrieval in place of the identified keyword and attribute information such that the attribute information associated with the identified keyword (the original attribute information 501) is the attribute information after conversion 502 stored in the paraphrase knowledge DB 139 (S807). The keyword addition determining module 134 repeats performing steps of S806 and 5807 until no keywords requiring paraphrasing are left.

When there are no keywords requiring paraphrasing left (No at S806), the analysis result storage 135 stores in the request analysis information DB 130 the request analysis information including the keyword 604, the attribute information 602, the attribute candidate information 603, the ID 601, and the flag 605 “0” identified by the intention analyzer 133 (S808). If, at this time, the keyword identified by the intention analyzer 133 is one converted from the second keyword by the keyword addition determining module 134, the analysis result storage 135 includes the related ID 606 that represents the ID 601 of the request analysis information including the second keyword in the request analysis information. Additionally, the analysis result storage 135 stores in the request analysis information DB 130 the request analysis information that includes the second keyword (keyword 604), the second attribute information (attribute information 602), the ID 601, the flag 605 “1”, and the related ID 606 identified by the keyword addition determining module 134.

Next, the retrieval performing module 136 directs content retrieval by transmitting to the television broadcast display set 2 the keyword 604 and the attribute information 602 included in the request analysis information stored in the request analysis information DB 130 (S809). For example, the retrieval performing module 136 directs the content retrieval by transmitting to the television broadcast display set 2 the keyword 604 “movies” and the attribute information 602 “category”, and the keyword 604 “Harry Potter” and the attribute information 602 “program name” included in the request analysis information stored in the request analysis information DB 130. It is noted that, if the flag 605 included in the request analysis information stored in the request analysis information DB 130 is “1”, the retrieval performing module 136 directs the content retrieval by transmitting to the television broadcast display set 2, in place of the keyword 604 and the attribute information 602 included in the request analysis information, the keyword 604 as a second keyword and the attribute information 602 as second attribute information included in the request analysis information that includes the related ID 606 included in the request analysis information in question as the ID 601.

Finally, the result generator 137 outputs to the response display controller 16 the request analysis information stored in the request analysis information DB 130 and a result of the content retrieval performed in the television broadcast display set 2 according to the retrieval instruction issued by the retrieval performing module 136 (S810). This causes the content retrieval screen X to be displayed on the display module 201, the content retrieval screen X displaying the retrieval conditions (the keyword 604 and the attribute information 602) included in the request analysis information and the retrieval result.

Specifically, as illustrated in FIG. 9A, if the voice “I want to watch a Harry Potter movie” is received by the voice input receiver 131, the response display controller 16 displays, on receipt of the result of the content retrieval performed in the television broadcast display set 2, the received retrieval result R1 in the retrieval result display area X1.

In addition, if the attribute candidate information 603 is not included in the received request analysis information stored in the request analysis information DB 130, the response display controller 16 causes the keyword 604 “movies” and the attribute information 602 “category” included in the received request analysis information to be displayed, as illustrated in FIG. 9A, as the retrieval conditions R2 in the retrieval condition display area X2. This allows the user of the tablet terminal 1 to be notified that the content has been retrieved with the keyword 604 “movies” interpreted as the attribute information 602 “category”. The response display controller 16 controls this display such that an association between the keyword 604 “movies” and the attribute information 602 “category” is identifiable, for example, the keyword 604 “movies” and the attribute information 602 “category” are displayed close to each other.

Furthermore, if the received request analysis information includes the keyword 604 “Harry Potter”, the attribute information 602 “program name”, and the attribute candidate information 603 “character's name”, the response display controller 16 causes the attribute candidate information 603 “character's name” to be displayed, as illustrated in FIG. 9A, as the attribute candidate information R3 in the retrieval condition display area X2, together with the retrieval conditions R2 including the keyword 604 “Harry Potter” and the attribute information 602 “program name”. The user of the tablet terminal 1 can input a condition change instruction that directs a change in the attribute information by selecting the attribute candidate information R3 displayed in the retrieval condition display area X2. Alternatively, when the attribute candidate information 603 “character's name” is to be displayed as the attribute candidate information R3 in the retrieval condition display area X2, together with the retrieval conditions R2 including the keyword 604 “Harry Potter” and the attribute information 602 “program name”, the response display controller 16 may cause information “D. Radcliffe” to be displayed as supplementary information R5 as illustrated in FIG. 9B, the information “D. Radcliffe” being to be used as a retrieval keyword when the attribute candidate information R3 (the attribute candidate information 603 “character's name”) is selected as an alternative to the attribute information 602 “program name”.

The exemplary content retrieval screen X illustrated in FIG. 9A illustrates only one piece of attribute candidate information 603. The response display controller 16 is, nonetheless, capable of causing a plurality of pieces of attribute candidate information 603. If all of the multiple pieces of attribute candidate information 603 cannot be placed within the retrieval condition display area X2, the response display controller 16 may cause a button (not illustrated) that directs the display of the attribute candidate information 603 through a display method, such as a pull-down menu, to be displayed and cause the attribute candidate information 603 to be displayed in the retrieval condition display area X2 only when the button is depressed. Alternatively, the response display controller 16 may cause any other type of button (not illustrated) that directs the display of the attribute candidate information 603 to be displayed in the retrieval condition display area X2 and cause a list of attribute information (e.g., “category”, “character's name”, “actor/actress”, “period”, “period expression”, “date expression”, “broadcast station”, “program name”, “CS”, and “BS”) to be displayed when the other type of button is depressed.

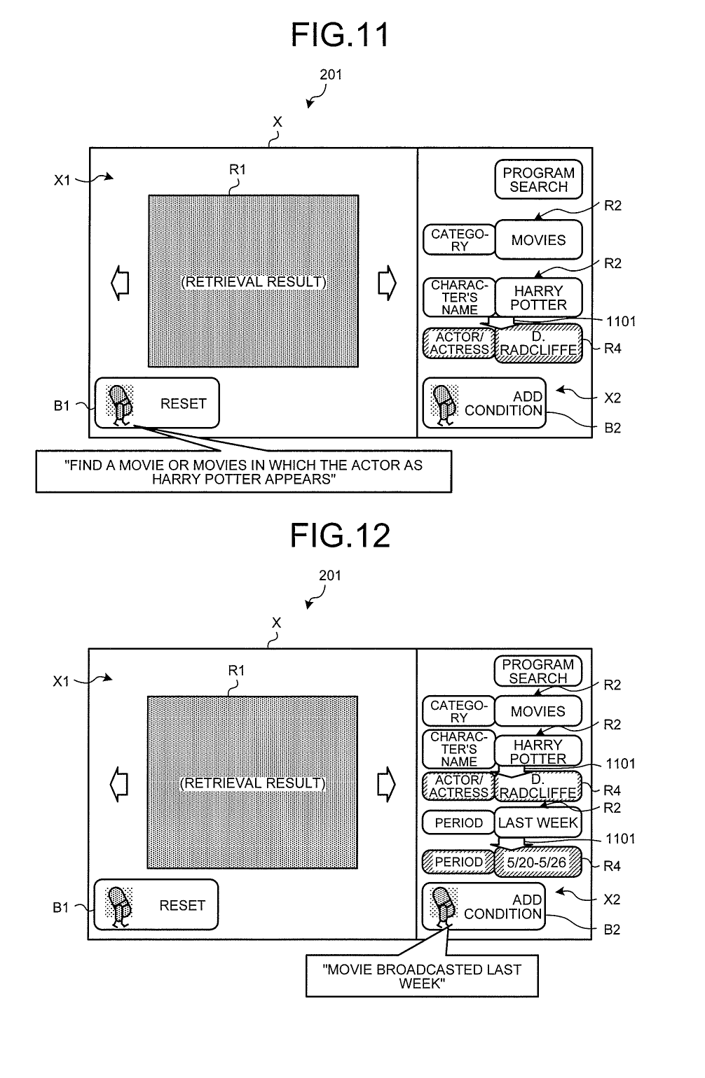

FIG. 11 is an exemplary diagram illustrating a content retrieval screen displayed on the display module of the tablet terminal in the embodiment. If the voice input receiver 131 receives the voice “Find a movie or movies in which the actor as Harry Potter appears” as illustrated in FIG. 11 and the received request analysis information includes the keyword 604 “Harry Potter”, the attribute information 602 “character's name”, and the related ID 606 “3” as illustrated in the example of FIG. 6, the response display controller 16 causes a second retrieval condition R4 that includes the keyword 604 “D. Radcliffe” and the attribute information 602 “actor/actress” included in the request analysis information having the related ID 606 “3” as the ID 601 to be displayed in the retrieval condition display area X2, together with the retrieval conditions R2 including the keyword 604 “Harry Potter” and the attribute information 602 “character's name”. At this time, the response display controller 16 causes a marker (an arrow denoted by reference numeral 1101 in the embodiment) to be displayed on the display module 201, the marker indicating that the content has been retrieved using the second retrieval condition R4 that includes the keyword 604 “D. Radcliffe” and the attribute information 602 “actor/actress” in place of the retrieval conditions R2 including the keyword 604 “Harry Potter” and the attribute information 602 “character's name”. This allows the user to understand easily the reason why the retrieval result R1 displayed in the retrieval result display area X1 has been obtained.

It is noted that the second retrieval condition R4 does not represent a keyword to be changed and serves as supplementary information to be used for content retrieval. The second retrieval condition R4 may therefore be displayed in a color different from that of the retrieval conditions R2 or otherwise in a different display mode, so that it is clearly known that the second retrieval condition R4 differs from the retrieval conditions R2. In addition, the second retrieval condition R4 cannot be selected as a keyword to be changed as described above. If the second retrieval condition R4 is to be changed, the selection of a keyword of the retrieval conditions R2 is necessary.

A process to be performed by the additional request processor 14 to add a content retrieval condition will be described below with reference to FIG. 12. FIG. 12 is an exemplary diagram illustrating a content retrieval screen displayed on the display module of the tablet terminal in the embodiment.

Referring to FIG. 12, when the “Add condition” button B2 is depressed and a condition addition instruction is determined by the input type determining module 12, the additional request processor 14 receives voice input from the microphone 202 (e.g., “movie broadcasted last week”). As in the new request processor 13, the additional request processor 14 identifies a keyword (e.g., “last week”) and attribute information (e.g., “period”) associated with the keyword from the input voice. The additional request processor 14 then converts the identified keyword and attribute information to a second keyword (e.g., “5/20 to 5/26”) and second attribute information (e.g., “period”) to be used for content retrieval in place of the identified keyword and attribute information. The additional request processor 14 next additionally stores request analysis information including the identified keyword and attribute information and request analysis information including the second keyword and the second attribute information in the request analysis information DB 130.

Then, as illustrated in FIG. 12, the additional request processor 14 causes the retrieval conditions R2 including the keyword 604 (e.g., “last week”) and the attribute information 602 (e.g., “period”) included in the request analysis information that is additionally stored in the request analysis information DB 130 and the second retrieval condition R4 including the keyword 604 (e.g., “5/20 to 5/26”) as the second keyword and the attribute information 602 (e.g., “period”) as the second attribute information included in the request analysis information that is additionally stored in the request analysis information DB 130 to be displayed on the retrieval condition display area X2. Furthermore, the additional request processor 14 causes a marker (the arrow denoted by reference numeral 1101 in the embodiment) to be displayed on the display module 201, the marker indicating that the content has been retrieved using the second retrieval condition R4 that includes the keyword 604 “5/20 to 5/26” and the attribute information 602 “period” in place of the retrieval conditions R2 including the keyword 604 “last week” and the attribute information 602 “period”.

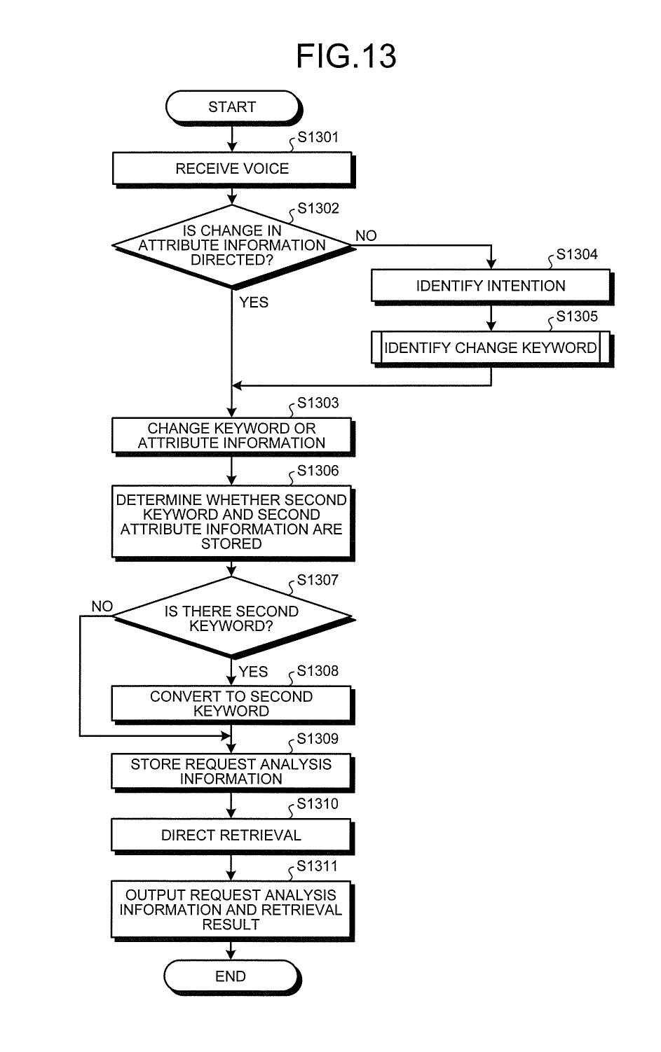

Steps of a retrieval condition change process performed by the change request processor 15 will be described below with reference to FIG. 13. FIG. 13 is a flowchart illustrating the steps of a retrieval condition change process performed by the change request processor of the tablet terminal in the embodiment.

When a keyword included in the retrieval conditions R2 displayed in the retrieval condition display area X2 of the content retrieval screen X is selected and the input type determining module 12 determines a condition change instruction, the change input receiver 151 receives voice (e.g., “Ethan Hunt”) input from the microphone 202 (S1301). When the attribute candidate information R3 displayed in the retrieval condition display area X2 of the content retrieval screen X is selected and the input type determining module 12 determines a condition change instruction, the change input receiver 151 receives the selection of attribute candidate information from the attribute candidate information R3. When the condition change instruction is determined, the change processor 152 acquires the ID 601 of the request analysis information that includes the selected keyword or attribute candidate information, together with details of the change.

The change processor 152 then determines whether the condition change instruction directs a change in attribute information based on whether the keyword included in the retrieval conditions R2 or the attribute candidate information R3 displayed in the retrieval condition display area X2 of the content retrieval screen X is selected (S1302). If it is determined that the attribute candidate information R3 has been selected to direct a change in attribute information (Yes at S1302), the change processor 152 identifies a specific piece of request analysis information from among those in the request analysis information DB 130 using the acquired ID 601 and changes the attribute information 602 included in the identified request analysis information to the selected attribute candidate information (S1303).

If it is determined, on the other hand, that the keyword included in the retrieval conditions R2 has been selected to direct a change in the keyword (No at S1302), the change processor 152 identifies the intention of the input voice (S1304) as at 5803 performed by the voice recognition module 132 and identifies the change keyword to be used for the change of the keyword and attribute information associated with the change keyword (S1305). Then, the change processor 152 identifies a specific piece of request analysis information from among those in the request analysis information DB 130 using the acquired ID 601 and changes the keyword 604 included in the identified request analysis information to the identified change keyword (S1303).

The keyword addition determining module 154 determines whether there are a second keyword and second attribute information to be used for content retrieval in place of the keyword 604 and the attribute information 602 changed by the change processor 152 (S1306). If the attribute information 602 associated with the keyword 604 changed by the change processor 152 (or the attribute information 602 changed by the change processor 152) falls into any of pieces of the original attribute information 501 stored in the paraphrase knowledge DB 139, the keyword addition determining module 154 then determines that there are the second keyword and the second attribute information (Yes at S1307). In this case, the keyword addition determining module 154 converts the changed keyword 604 and attribute information 602 to the second keyword and the second attribute information to be used for the content retrieval in place of the keyword 604 and the attribute information 602 in question (S1308).

The change storage 155 stores in the request analysis information DB 130 the request analysis information having at least one of the keyword 604 and the attribute information 602 changed by the change processor 152 and the request analysis information that includes the second keyword and the second attribute information after the conversion by the keyword addition determining module 154 (S1309).

If, at this time, the request analysis information with the ID 601 acquired by the change processor 152 includes the related ID 606 and has undergone the conversion to the second keyword and the second attribute information by the keyword addition determining module 154, the change storage 155 stores in the request analysis information DB 130 the keyword 604 and the attribute information 602 included in the request analysis information identified by the related ID 606, including the second keyword and the second attribute information after the conversion.

If the request analysis information with the ID 601 acquired by the change processor 152 does not include the related ID 606 and has undergone the conversion to the second keyword and the second attribute information by the keyword addition determining module 154, the change storage 155 generates and stores in the request analysis information DB 130 new request analysis information that includes the second keyword and the second attribute information as the keyword 604 and the attribute information 602. The change storage 155 then records the ID 601 of the newly generated request analysis information in the related ID 606 of the request analysis information that corresponds to the ID 601 acquired by the change processor 152.

Additionally, if the request analysis information with the ID 601 acquired by the change processor 152 includes the related ID 606 and the keyword addition determining module 154 has determined that there are no second keyword or second attribute information to be used for the content retrieval in place of the keyword 604 and the attribute information 602, the change storage 155 deletes the request analysis information identified by the related ID 606 from the request analysis information DB 130. Similarly, the change storage 155 also deletes the ID 601 recorded in the related ID 606 of the ID 601 acquired by the change processor 152.

The retrieval performing module 136 directs content retrieval by transmitting to the television broadcast display set 2 the keyword 604 and the attribute information 602 for retrieval included in the request analysis information stored in the request analysis information DB 130 (S1310). Finally, the result generator 137 outputs to the response display controller 16 the request analysis information stored in the request analysis information DB 130, and a result of the content retrieval performed in the television broadcast display set 2 according to the retrieval instruction issued by the retrieval performing module 136 (S1311).

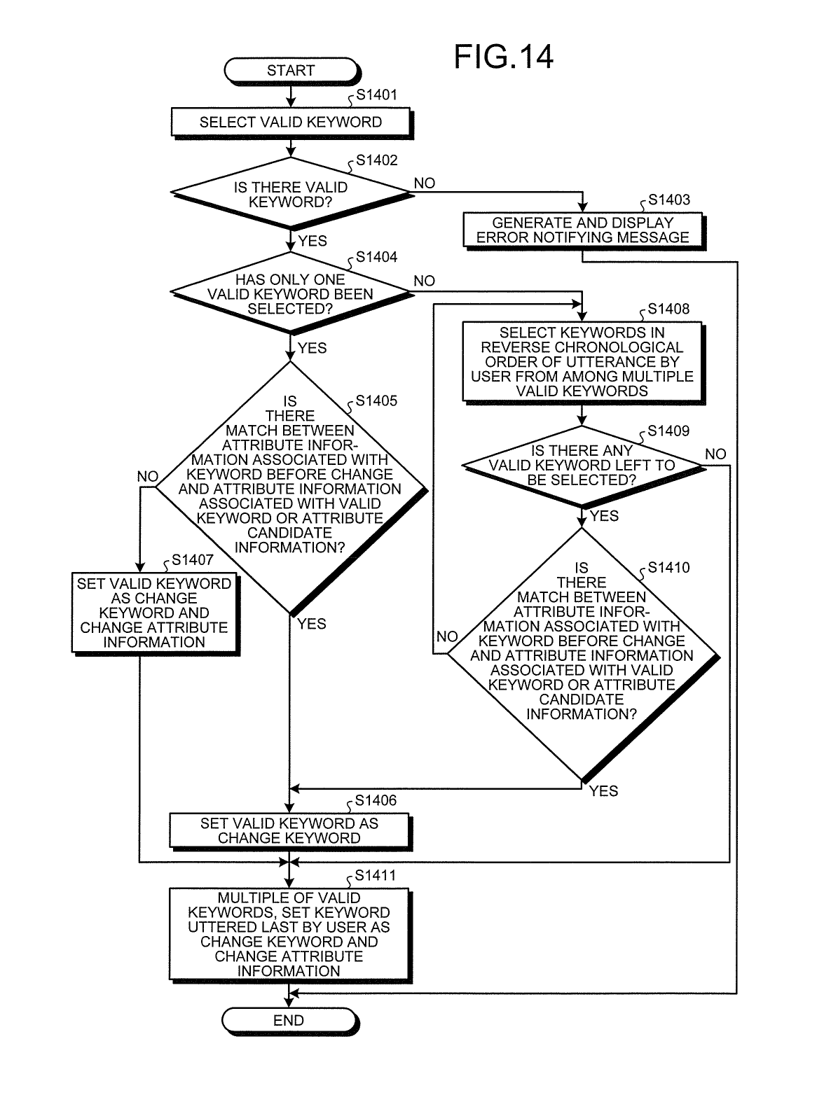

Steps of a process for identifying the change keyword illustrated at S1305 of FIG. 13 will be described below with reference to FIG. 14. FIG. 14 is a flowchart illustrating steps of a change keyword identifying process performed by the change processor of the tablet terminal in the embodiment.

The change processor 152 selects, from among a plurality of keywords identified by the input voice, keywords (hereinafter referred to as “valid keywords”) that are associated with attribute information different from the attribute information 602 included in, out of the request analysis information stored in the request analysis information DB 130, the request analysis information other than the request analysis information identified by the acquired ID 601 (S1401). At this time, the change processor 152 selects as the valid keywords those keywords associated with the same attribute information as the attribute information 602 included in the request analysis information identified by the acquired ID 601.

Next, the change processor 152 determines whether a valid keyword or keywords have been selected (S1402). If no valid keywords have been selected (No at S1402), the change processor 152 generates an error notifying message that notifies that no keywords have been identified from the input voice and causes the message to be displayed on the display module 201 via the response display controller 16 (S1403).

If a valid keyword has been selected (Yes at S1402), the change processor 152 determines whether only one valid keyword has been selected or a plurality of valid keywords have been selected (S1404). If only one valid keyword has been selected (Yes at S1404), the change processor 152 determines whether there is a match between the attribute information associated with the keyword before the change (the attribute information 602 included in the request analysis information identified by the acquired ID 601) and a single piece of attribute information associated with the selected valid keyword or the attribute candidate information that replaces the single piece of attribute information (S1405).

If there is a match between the attribute information associated with the keyword before the change and the attribute information or the attribute candidate information associated with the valid keyword (Yes at S1405), the change processor 152 sets the valid keyword as the change keyword of the keyword 604 included in the request analysis information identified by the acquired ID 601 (S1406). If the attribute information associated with the keyword 604 before the change matches the attribute candidate information of the valid keyword, the change processor 152 defines the attribute information associated with the valid keyword to be the attribute candidate information and the attribute information associated with the keyword 604 before the change to be the attribute information of the valid keyword.

If there is a mismatch between the attribute information associated with the keyword before the change and the attribute information or the attribute candidate information associated with the valid keyword (No at S1405), the change processor 152 sets the valid keyword as the change keyword and the attribute information or the attribute candidate information associated with the valid keyword as the attribute information 602 and the attribute candidate information 603 included in the request analysis information identified by the acquired ID 601 (S1407).

If a plurality of valid keywords have been selected (No at S1404), the change processor 152 selects keywords in reverse chronological order of utterance by the user from among the multiple valid keywords (S1408). If a valid keyword is selected (Yes at S1409), the change processor 152 determines whether there is a match between the attribute information associated with the keyword before the change and the attribute information associated with the selected valid keyword or the attribute candidate information that replaces the attribute information (S1410).

If there is a match between the attribute information associated with the keyword before the change and the attribute information or the attribute candidate information associated with the selected valid keyword (Yes at S1410), the change processor 152 sets the selected valid keyword as the change keyword of the keyword 604 included in the request analysis information identified by the acquired ID 601 (S1406). If, on the other hand, there is a mismatch between the attribute information associated with the keyword before the change and the attribute information or the attribute candidate information associated with the selected valid keyword (No at S1410), the change processor 152 returns to S1408 and repeats selecting the valid keywords until the change keyword is determined at S1406.

When all valid keywords have been selected to leave none left (No at S1409), the change processor 152 sets as the change keyword the keyword that is identified with the voice input last by the user from among the multiple valid keywords (S1411). Additionally, the change processor 152 defines the attribute information and the attribute candidate information associated with the change keyword in question to be the attribute information 602 and the attribute candidate information included in the request analysis information identified by the acquired ID 601.

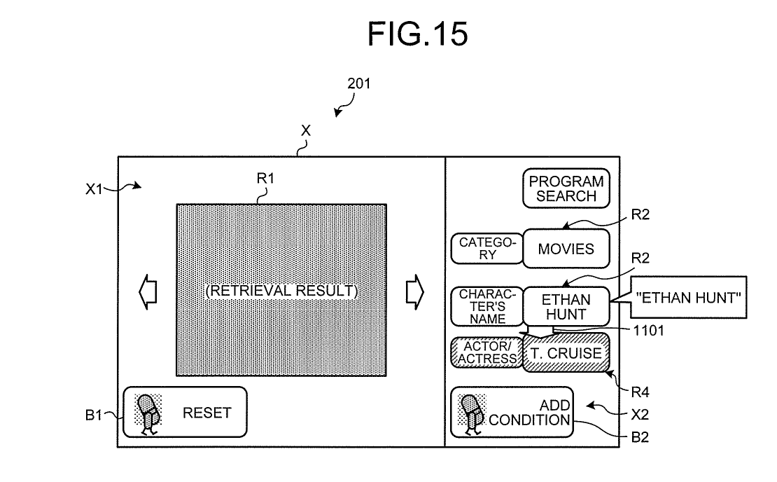

Referring to FIGS. 9A and 15, the content retrieval screen X will be described below, the content retrieval screen X being to be displayed on the display module 201 of the tablet terminal 1 in the embodiment when the keyword or attribute information to be used for content retrieval is changed. FIG. 15 is an exemplary diagram illustrating the content retrieval screen displayed on the display module of the tablet terminal in the embodiment.

When the keyword 604 “Harry Potter” included in the retrieval conditions R2 displayed in the retrieval condition display area X2 of the content retrieval screen X illustrated in FIG. 9A is selected, the change input receiver 151 is ready to receive voice to be input from the microphone 202. When the change input receiver 151 receives, for example, the voice “Ethan Hunt” or “I insist on Ethan Hunt”, the change processor 152 selects “Ethan Hunt” for the change keyword to be used for changing the keyword 604 “Harry Potter”, thereby changing the keyword 604 “Harry Potter” included in the request analysis information with the acquired ID 601 to the selected change keyword “Ethan Hunt”.

The keyword addition determining module 154 identifies a second keyword “T. Cruise” and second attribute information “actor/actress” to be used for the content retrieval in place of the change keyword “Ethan Hunt” and the attribute information “character's name” associated with the change keyword. The change storage 155 then stores in the request analysis information DB 130 the request analysis information that includes the identified second keyword “T. Cruise” and second attribute information “actor/actress”.

When the request analysis information stored in the request analysis information DB 130 is thereafter output to the response display controller 16, the response display controller 16 displays, as illustrated in FIG. 15, in the retrieval condition display area X2 the retrieval conditions R2 that include the keyword 604 “Ethan Hunt” and the attribute information 602 “character's name” and the second retrieval condition R4 that includes the keyword 604 “T. Cruise” as the second keyword and the attribute information 602 “actor/actress” as the second attribute information.

In addition, the response display controller 16 displays a marker (the arrow denoted by reference numeral 1101 in the embodiment) on the display module 201, the marker indicating that the content has been retrieved using the second retrieval condition R4 that includes the keyword 604 “T. Cruise” and the attribute information 602 “actor/actress” in place of the retrieval conditions R2 that include the keyword 604 “Ethan Hunt” and the attribute information 602 “character's name”. This allows the user to understand easily the reason why the retrieval result R1 displayed in the retrieval result display area X1 has been obtained. The foregoing also clarifies how the tablet terminal 1 has recognized the voice input by the user. Furthermore, the response display controller 16 causes a result of the content retrieval performed using the keyword 604 “T. Cruise” and the attribute information 602 “actor/actress” and the keyword 604 “movies” and the attribute information 602 “category” in the retrieval result display area X1.

It is noted that the voice input receiver 131, the voice recognition module 132, the intention analyzer 133, the keyword addition determining module 134, the result generator 137, the change input receiver 151, the change processor 152, the keyword addition determining module 154, and the response display controller 16 in the embodiment function as the display controller.

As described heretofore, when a change needs to be made in attribute information associated with a keyword identified from information input for content retrieval, the tablet terminal 1 in the embodiment eliminates the need for re-inputting information such that the attribute information associated with the identified keyword is desired attribute information. This improves convenience in content retrieval processing.

In the embodiment, a program to be executed by the tablet terminal 1 (such as, a television operation application) may be provided by being recorded on a computer-readable recording medium, such as a compact disc read-only memory (CD-ROM), a flexible disk (FD), a compact disc recordable (CD-R), and a digital versatile disk (DVD), in a file in an installable format or an executable format.

The program to be executed by the tablet terminal 1 of the embodiment may also be configured so as to be stored in a computer connected to a network such as the Internet and to be downloaded over the network. The program to be executed by the tablet terminal 1 of the embodiment may still be configured so as to be provided or distributed over a network such as the Internet.

The program to be executed by the tablet terminal 1 of the embodiment may even be configured so as to be provided by being incorporated in advance in a ROM or another storage device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
an input module configured to receive voice input therein;
a display controller configured to identify from the input voice a keyword and a single piece of attribute information associated with the keyword to be used for content retrieval and to cause to display on a display the identified keyword and the identified attribute information, and attribute candidate information that is associated with the identified keyword and selectable as an alternative to the identified attribute information; and
a retrieval instructing module configured to give an instruction for the content retrieval using the identified keyword and the selected attribute candidate information.

2. The information processing device of claim 1, wherein the identified keyword is changeable for each the keyword.

3. The information processing device of claim 1, wherein
the display controller is configured to identify, from the identified keyword and the identified attribute information or the selected attribute candidate information, a second keyword and second attribute information associated with the second keyword to be used for content retrieval, in place of the identified keyword and the identified attribute information or the selected attribute candidate information, in accordance with a previously set conversion rule to display the second keyword and the second attribute information on the display, and
the retrieval instructing module is configured to give the instruction for the content retrieval using the second keyword and the second attribute information.

4. A content retrieval method comprising:
inputting voice;
identifying from the input voice a keyword and a single piece of attribute information associated with the keyword to be used for content retrieval and to cause to display on a display the identified keyword and the identified attribute information, and attribute candidate information that is associated with the identified keyword and selectable as an alternative to the identified attribute information; and
giving an instruction for the content retrieval using the identified keyword and the selected attribute candidate information.
